(19) United States
(12) Patent Application Publication
(10) Pub. No.: US 2023/0080431 A1
(43) Pub. Date: Mar. 16, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 17/801,053

(22) PCT Filed: Feb. 21, 2020
(86) PCT No.: PCT/JP2020/007210

§ 371 Date: Aug. 19, 2022

(51) Int. Cl. H04L 5/00; H04W 52/24

(52) U.S. Cl. CPC H04L 5/0048; H04W 52/245

(57) ABSTRACT

A terminal according to one aspect of the present disclosure includes: a receiving section that receives configuration information related to an uplink signal; and a control section that uses, in a case where the configuration information satisfies an application condition and quasi-co-location (QCL) type D in a transmission configuration indication (TCI) state for a downlink channel is not a periodic reference signal, a reference signal of at least one of QCL type A and the QCL type D in the TCI state, for calculation of a pathloss of the uplink signal. According to one aspect of the present disclosure, it is possible to appropriately transmit a UL signal.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

In existing LTE systems (for example, 3GPP Rel. 8 to Rel. 14), a user terminal (User Equipment (UE)) transmits uplink control information (UCI) by using at least one of a UL data channel (for example, a Physical Uplink Shared Channel (PUSCH)) and a UL control channel (for example, a Physical Uplink Control Channel (PUCCH)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied that a user terminal (a terminal, a User Equipment (UE)) controls transmission/reception processing on the basis of information related to quasi-co-location (QCL).

However, a pathloss reference signal (PL-RS) is not clear in some cases. Unless the UE can appropriately calculate pathloss, the UE fails to appropriately transmit a UL signal, and this may cause deterioration in system performance, such as a decrease of throughput.

Thus, an object of the present disclosure is to provide a terminal, a radio communication method, and a base station that are for appropriately transmitting a UL signal.

### Solution to Problem

A terminal according to one aspect of the present disclosure includes: a receiving section that receives configuration information related to an uplink signal; and a control section that uses, in a case where the configuration information satisfies an application condition and quasi-co-location (QCL) type D in a transmission configuration indication (TCI) state for a downlink channel is not a periodic reference signal, a reference signal of at least one of QCL type A and the QCL type D in the TCI state, for calculation of a pathloss of the uplink signal.

### Advantageous Effects of Invention

According to one aspect of the present disclosure, it is possible to appropriately transmit a UL signal.

### BRIEF DESCRIPTION OF DRAWINGS

FIG. 1 is a diagram to show an example of update of a PL-RS;

FIG. 2 is a diagram to show an example of operation according to Embodiment 3;

FIG. 3 is a diagram to show an example of a schematic structure of a radio communication system according to one embodiment;

FIG. 4 is a diagram to show an example of a structure of a base station according to one embodiment;

FIG. 5 is a diagram to show an example of a structure of a user terminal according to one embodiment; and

FIG. 6 is a diagram to show an example of a hardware structure of the base station and the user terminal according to one embodiment.

### DESCRIPTION OF EMBODIMENTS

### (TCI, Spatial Relation, QCL)

For NR, it is studied to perform control of reception processing (for example, at least one of reception, demapping, demodulation, and decoding) and transmission processing (for example, at least one of transmission, mapping, precoding, modulation, and coding) of at least one of a signal and a channel (referred to as a signal/channel) in a UE on the basis of a transmission configuration indication state (TCI state).

The TCI state may be a state applied to a downlink signal/channel. A state that corresponds to the TCI state applied to an uplink signal/channel may be expressed as a spatial relation.

The TCI state is information related to quasi-co-location (QCL) of the signal/channel, and may be referred to as a spatial reception parameter, spatial relation information, or the like. The TCI state may be configured for the UE for each channel or for each signal.

Note that, in the present disclosure, a TCI state of the DL may be interpreted as a spatial relation of the UL, a TCI state of the UL, and the like interchangeably.

QCL is an indicator indicating statistical properties of the signal/channel. For example, when a certain signal/channel and another signal/channel are in a relationship of QCL, it may be indicated that it is assumable that at least one of Doppler shift, Doppler spread, an average delay, delay spread, and a spatial parameter (for example, a spatial reception parameter (spatial Rx parameter)) is the same (the relationship of QCL is satisfied in at least one of these) between the plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread,
QCL type B (QCL-B): Doppler shift and Doppler spread,
QCL type C (QCL-C): Doppler shift and average delay, and
QCL type D (QCL-D): spatial reception parameter.

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

In the present disclosure, for example, the higher layer signaling may be any one or combination of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

A channel for which the TCI state or a spatial relation is configured (indicated) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

The UE may receive configuration information (for example, PDSCH-Config or tci-StatesToAddModList) including a list of information elements of the TCI state by higher layer signaling.

An information element of the TCI state (“TCI-state IE” of RRC) configured by higher layer signaling may include a TCI state ID and one or a plurality of pieces of QCL information (“QCL-Info”). The QCL information may include at least one of information related to the RS to have a QCL relationship (RS relation information) and information indicating a QCL type (QCL type information). The RS relation information may include information such as an index of the RS (for example, an SSB index or a non-zero-power (NZP) CSI-RS resource ID (Identifier)), an index of a cell in which the RS is located, and an index of a Bandwidth Part (BWP) in which the RS is located.

In Rel-15 NR, both an RS of QCL type A and an RS of QCL type D or only the RS of QCL type A can be configured, for the UE, as a TCI state of at least one of a PDCCH and a PDSCH.

In a case where a TRS is configured as the RS of QCL type A, it is assumed, for the TRS, that the same TRS is transmitted periodically over a long time period, different from a demodulation reference signal (DMRS) for the PDCCH or the PDSCH. The UE can measure the TRS and thereby calculate an average delay, delay spread, or the like.

The UE configured with the TRS as the RS of QCL type A for the TCI state of the DMRS of the PDCCH or the PDSCH can assume that parameters (average delay, delay spread, or the like) of QCL type A are the same between the DMRS of the PDCCH or the PDSCH and the TRS and can hence obtain the parameter (average delay, delay spread, or the like) of type A of the DMRS of the PDCCH or the PDSCH from a measurement result of the TRS. In performing channel estimation of at least one of the PDCCH and the PDSCH, the UE can use the measurement result of the TRS to perform channel estimation with higher accuracy.

The UE configured with the RS of QCL type D can determine a UE receive beam (a spatial domain reception filter, a UE spatial domain reception filter) by using the RS of QCL type D.

An RS of QCL type X in a TCI state may mean an RS in a relationship of QCL type X with (a DMRS of) a certain channel/signal and may be referred to as a QCL source of QCL type X in the TCI state.

### <TCI State for PDCCH>

Information related to QCL between a PDCCH (or a DMRS antenna port related to the PDCCH) and a certain RS may be referred to as a TCI state for the PDCCH and the like.

The UE may determine a TCI state for a UE-specific PDCCH (CORESET) on the basis of higher layer signaling. For example, one or a plurality of (K) TCI states may be configured per CORESET for the UE by RRC signaling.

The UE may activate, by a MAC CE, one of the plurality of TCI states configured by the RRC signaling, for each CORESET. The MAC CE may be referred to as a TCI state indication for UE-specific PDCCH MAC CE. The UE may monitor the CORESET on the basis of an active TCI state corresponding to the CORESET.

### <TCI State for PDSCH>

Information related to QCL between a PDSCH (or a DMRS antenna port related to the PDSCH) and a certain DL-RS may be referred to as a TCI state for the PDSCH and the like.

The UE may be notified of (configured with) M (M≥1) TCI state(s) for the PDSCH (M pieces of QCL information for the PDSCH) by higher layer signaling. Note that the number M of TCI states configured for the UE may be restricted according to at least one of UE capability and a QCL type.

DCI used for scheduling the PDSCH may include a field indicating the TCI state(s) for the PDSCH (which may be referred to as a TCI field, a TCI state field, and the like, for example). The DCI may be used for the scheduling of the PDSCH in a single cell and may be referred to as DL DCI, a DL assignment, DCI format 1_0, DCI format 1_1, and the like, for example.

Whether the TCI field is included in the DCI may be controlled on the basis of information of which the UE is notified by a base station. The information may be information indicating whether the TCI field is present or absent in the DCI (for example, TCI presence information, TCI-presence-in-DCI information, a higher layer parameter TCI-PresentInDCI). The information may be configured for the UE by higher layer signaling, for example.

In a case where more than eight kinds of TCI states are configured for the UE, eight or fewer kinds of TCI states may be activated (or specified) by using a MAC CE. The MAC CE may be referred to as a TCI states Activation/Deactivation for UE-specific PDSCH MAC CE. A value of the TCI field in the DCI may indicate one of the TCI states activated by the MAC CE.

In a case where the UE is configured with TCI presence information set to “enabled” for a CORESET for scheduling the PDSCH (the CORESET used for transmission of a PDCCH for scheduling the PDSCH), the UE may assume that the TCI field is present in DCI format 1_1 of the PDCCH transmitted in the CORESET.

Assume a case where the TCI presence information is not configured for the CORESET for scheduling the PDSCH or the PDSCH is scheduled by DCI format 1_0. In this case, when a time offset between reception of DL DCI (the DCI for scheduling the PDSCH) and reception of the PDSCH corresponding to the DCI is equal to or larger than a threshold, the UE may assume that the TCI state or a QCL assumption for the PDSCH is the same as a TCI state or a QCL assumption applied to the CORESET used for the PDSCH transmission for scheduling the PDSCH, to determine QCL of a PDSCH antenna port.

In a case where the TCI presence information is set to “enabled,” a TCI field in DCI in a component carrier (CC) for the scheduling (of the PDSCH) indicates a TCI state activated in the CC or a DL BWP for the scheduling and the PDSCH is scheduled by DCI format 1_1, the UE may use a TCI according to a value of the TCI field in the PDCCH detected with the DCI, to determine QCL of the antenna port of the PDSCH. When the time offset between the reception of the DL DCI (for scheduling the PDSCH) and the PDSCH corresponding to the DCI (the PDSCH scheduled by the DCI) is equal to or larger than the threshold, the UE may assume that a DM-RS port of the PDSCH in a serving cell is QCLed (quasi co-located) with an RS in a TCI state related to a QCL type parameter given by an indicated TCI state.

In a case where the UE is configured with a single-slot PDSCH, the indicated TCI state may be based on the activated TCI state in a slot including the scheduled PDSCH. In a case where the UE is configured with a multi-slot PDSCH, the indicated TCI state may be based on the activated TCI state in the first slot including the scheduled PDSCH, and the UE may expect that the TCI state is the same over the slots including the scheduled PDSCH. In a case where the UE is configured with the CORESET associated with a search space set for cross-carrier scheduling, the UE is configured with the TCI presence information being set to “enabled” for the CORESET. In a case where at least one of the TCI states configured for the serving cell scheduled by the search space set includes QCL type D, the UE may assume that a time offset between the detected PDCCH and the PDSCH corresponding to the PDCCH is equal to or larger than the threshold.

Assume, in an RRC connected mode, both a case where the TCI-in-DCI information (the higher layer parameter TCI-PresentInDCI) is set to “enabled” and a case where the TCI-in-DCI information is not configured. In this case, when the time offset between the reception of the DL DCI (the DCI scheduling the PDSCH) and the corresponding PDSCH (the PDSCH scheduled by the DCI) is lower than the threshold, the UE may assume that the DM-RS port of the PDSCH of the serving cell is QCLed with an RS related to a QCL parameter used for a QCL indication of the PDCCH in the CORESET that has the lowest (smallest) CORESET-ID in the newest (latest) slot in which one or more CORESETs in the active BWP of the serving cell is monitored by the UE and that is associated with a monitored search space. This RS may be referred to as a default TCI state of the PDSCH or a default QCL assumption of the PDSCH.

The time offset between the reception of the DL DCI and the reception of the PDSCH corresponding to the DCI may be referred to as a scheduling offset.

The threshold may be referred to as a time duration for QCL, “timeDurationForQCL,” a “Threshold,” a “Threshold for offset between a DCI indicating a TCI state and a PDSCH scheduled by the DCI,” “Threshold-Sched-Offset,” a schedule offset threshold, a scheduling offset threshold, and the like.

The time duration for QCL may be based on UE capability and may be based on a delay required for decoding of the PDCCH and beam switching, for example. The time duration for QCL may be the minimum time period necessary for the UE to perform PDCCH reception and application of spatial QCL information received in DCI for PDSCH processing. The time duration for QCL may be expressed by the number of symbols or may be expressed by a time period (for example, μs), per subcarrier spacing. Information of the time duration for QCL may be reported from the UE to the bae station as UE capability information or may be configured for the UE by the base station by using higher layer signaling.

For example, the UE may assume that the DMRS port of the PDSCH is QCLed with a DL-RS based on the TCI state activated for the CORESET corresponding to the lowest CORESET-ID. The newest slot may be, for example, a slot in which the DCI for scheduling the PDSCH is received.

Note that the CORESET-ID may be an ID configured by an RRC information element “ControlResourceSet” (an ID for identifying the CORESET, controlResourceSetId).

In a case where no CORESET is configured for a CC, a default TCI state may be an activated TCI state that is applicable to the PDSCH in the active DL BWP in the CC and that has the lowest ID.

Assume a case where, in Rel. 16 or later versions, a PDSCH and a PDCCH for scheduling the PDSCH are in different component carriers (CCs) (cross-carrier scheduling). In this case, when delay from the PDCCH to the PDSCH (PDCCH-to-PDSCH delay) is shorter than the time duration for QCL or when no TCI state is present in the DCI for the scheduling, the UE may acquire a QCL assumption for the scheduled PDSCH from the active TCI state that is applicable to the PDSCH in the active BWP of the scheduled cell and that has the lowest ID.

### <Spatial Relation for PUCCH>

The UE may be configured with a parameter (PUCCH configuration information, PUCCH-Config) used for PUCCH transmission by higher layer signaling (for example, Radio Resource Control (RRC) signaling). The PUCCH configuration information may be configured per partial bandwidth (for example, uplink bandwidth part (BWP)) in a carrier (also referred to as a cell and a component carrier (CC)).

The PUCCH configuration information may include a list of pieces of PUCCH resource set information (for example, PUCCH-ResourceSet) and a list of pieces of PUCCH spatial relation information (for example, PUCCH-SpatialRelationInfo).

The PUCCH resource set information may include a list (for example, resourceList) of PUCCH resource indices (IDs, for example, PUCCH-ResourceId).

In a case where the UE does not have dedicated PUCCH resource configuration information (for example, a dedicated PUCCH resource configuration) provided by way of the PUCCH resource set information in the PUCCH configuration information (before RRC setup), the UE may determine a PUCCH resource set on the basis of a parameter (for example, pucch-ResourceCommon) in system information (for example, System Information Block Type1 (SIB1) or Remaining Minimum System Information (RMSI)). The PUCCH resource set may include 16 PUCCH resources.

In contrast, in a case where the UE has the dedicated PUCCH resource configuration information (a UE-dedicated uplink control channel configuration, a dedicated PUCCH resource configuration) (after RRC setup), the UE may determine a PUCCH resource set according to the number of UCI information bits.

The UE may determine a single PUCCH resource (index) in the PUCCH resource set (for example, the PUCCH resource set determined in a cell-specific or UE-dedicated manner) on the basis of at least one of the value of a field (for example, a PUCCH resource indicator field) in downlink control information (DCI) (for example, DCI format 1_0 or 1_1 used for the scheduling of the PDSCH), the number (NccE) of CCEs in a control resource set (CORESET) for PDCCH reception for carrying the DCI, and an index (n_{CCE,0}) of the leading (first) CCE of the PDCCH reception.

The PUCCH spatial relation information (for example, the RRC information element “PUCCH-spatialRelationInfo”) may indicate a plurality of candidate beams (spatial domain filters) for the PUCCH transmission. The PUCCH spatial relation information may indicate spatial association between an RS (Reference signal) and the PUCCH.

The list of pieces of PUCCH spatial relation information may include several elements (PUCCH spatial relation information IEs (Information Elements)). Each piece of PUCCH spatial relation information may include, for example, at least one of the index (ID) of the PUCCH spatial relation information (for example, pucch-SpatialRelationInfoId), the index (ID) of the serving cell (for example, servingCellId), and information related to an RS (reference RS) to have a spatial relation with the PUCCH.

For example, the information related to the RS may be an SSB index, a CSI-RS index (for example, an NZP-CSI-RS resource configuration ID), or an SRS resource ID and the ID of a BWP. Each of the SSB index, the CSI-RS index, and the SRS resource ID may be associated with at least one of a beam, a resource, and a port selected on the basis of measurement of the corresponding RS.

In a case where more than one piece of spatial relation information related to the PUCCH is configured, the UE may perform such control that a single piece of PUCCH spatial relation information is active for a single PUCCH resource in a certain time period, on the basis of a PUCCH spatial relation activation/deactivation MAC CE.

The PUCCH spatial relation activation/deactivation MAC CE in Rel-15 NR is expressed with a total of three octets (8 bits×3=24 bits), i.e., octets (Octs) 1 to 3.

The MAC CE may include information such as an application target serving cell ID (a “Serving Cell ID” field), a BWP ID (a “BWP ID” field), and a PUCCH resource ID (a “PUCCH Resource ID” field).

The MAC CE includes a field “Sᵢ” (i=0 to 7). When the field of a certain Sᵢ indicates 1, the UE activates spatial relation information with spatial relation information ID When the field of a certain Sᵢ indicates 0, the UE deactivates the spatial relation information with spatial relation information ID

The UE may activate, 3 ms after transmitting positive acknowledgement (ACK) for the MAC CE for activating the PUCCH spatial relation information, the PUCCH relation information specified by the MAC CE.

### <Spatial Relation for SRS and PUCCH>

The UE may receive information to be used for transmission of a reference signal for measurement (for example, a sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example, an RRC control element “SRS-Resource”).

One SRS resource set may be related to several SRS resources (may group the several SRS resources). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and an SRS usage.

Here, the SRS resource type may indicate any of a periodic SRS (P-SRS), a semi-persistent SRS (SP-SRS), and an aperiodic SRS (A-SRS, AP-SRS). Note that the UE may transmit a P-SRS and an SP-SRS periodically (or, after activation, periodically) and transmit an A-SRS on the basis of an SRS request in the DCI.

The usage (an RRC parameter “usage,” an L1 (Layer-1) parameter “SRS-SetUse”) may be, for example, beam management (beamManagement), codebook based transmission (codebook (CB)), non-codebook based transmission (nonCodebook (NCB)), antenna switching (antennaSwitching), or the like. An SRS with a usage of codebook based transmission or non-codebook based transmission may be used for determination of a precoder for codebook based or non-codebook based PUSCH transmission based on the SRI.

For example, in a case of codebook based transmission, the UE may determine the precoder for the PUSCH transmission on the basis of the SRI, a transmitted rank indicator (TRI), and a transmitted precoding matrix indicator (TPMI). In a case of non-codebook based transmission, the UE may determine the precoder for the PUSCH transmission on the basis of the SRI.

The SRS resource information may include an SRS resource ID (SRS-ResourceId), the number of SRS ports, SRS port numbers, transmission Comb, SRS resource mapping (for example, a time and/or frequency resource position, a resource offset, resource periodicity, the number of repetitions, the number of SRS symbols, an SRS bandwidth, and the like), hopping related information, an SRS resource type, a sequence ID, spatial relation information of the SRS, and the like.

The spatial relation information of the SRS (for example, the RRC information element “spatialRelationInfo”) may indicate spatial relation information between a certain reference signal and the SRS. The reference signal may be at least one of a synchronization signal/broadcast channel (Synchronization Signal/Physical Broadcast Channel (SS/PBCH) block, a channel state information reference signal (CSI-RS), and an SRS (for example, another SRS). The SS/PBCH block may be referred to as a synchronization signal block (SSB).

The spatial relation information of the SRS may include at least one of an SSB index, a CSI-RS resource ID, and an SRS resource ID as the index of the reference signal.

Note that, in the present disclosure, the SSB index, the SSB resource ID, and an SSBRI (SSB Resource Indicator) may be interpreted interchangeably. The CSI-RS index, the CSI-RS resource ID, and a CRI (CSI-RS Resource Indicator) may be interpreted interchangeably. The SRS index, the SRS resource ID, and the SRI may be interpreted interchangeably.

The spatial relation information of the SRS may include a serving cell index, a BWP index (BWP ID) and the like corresponding to the reference signal.

In NR, transmission of an uplink signal may be controlled on the basis of presence or absence of beam correspondence (BC). The BC may be, for example, a capability of a certain node (for example, the base station or the UE) to determine a beam (transmit beam, Tx beam) to be used for transmission of a signal on the basis of a beam (receive beam, Rx beam) to be used for reception of a signal.

Note that the BC may be referred to as a transmit/receive beam correspondence (Tx/Rx beam correspondence), beam reciprocity, beam calibration, calibrated/non-calibrated, reciprocity calibrated/non-calibrated, the degree of correspondence, the degree of matching, and the like.

For example, in a case where the BC is absent, the UE may transmit an uplink signal (for example, a PUSCH, a PUCCH, an SRS, or the like) by using the same beam (spatial domain transmission filter) as that of an SRS (or an SRS resource) indicated by the base station, on the basis of a measurement result(s) of one or more SRSs (or RS resources).

In contrast, in a case where the BC is present, the UE may transmit an uplink signal (for example, a PUSCH, a PUCCH, an SRS, or the like) by using the same or a correspondence beam (spatial domain transmission filter) as or to a beam (spatial domain reception filter) to be used for reception of an SSB or a CSI-RS (or a CSI-RS resource).

In a case where spatial relation information related to the SSB or the CSI-RS and the SRS is configured for a certain SRS resource (for example, the case where the BC is present), the UE may transmit the SRS resource by using the same spatial domain filter (spatial domain transmission filter) as the spatial domain filter (spatial domain reception filter) for the reception of the SSB or the CSI-RS. In this case, the UE may assume that a UE receive beam for the SSB or the CSI-RS and a UE transmit beam for the SRS are the same.

In a case where spatial relation information related to another SRS (reference SRS) and the SRS (a target SRS) is configured for a certain SRS (target SRS) resource (for example, the case where the BC is absent), the UE may transmit the target SRS resource by using the same spatial domain filter (spatial domain transmission filter) as the spatial domain filter (spatial domain transmission filter) for the transmission of the reference SRS. In other words, in this case, the UE may assume that a UE transmit beam for the reference SRS and a UE transmit beam for the target SRS are the same.

The UE may determine, on the basis of the value of a field (for example, an SRS resource indicator (SRI) field) in DC I (for example, DCI format 0_1), the spatial relation of the PUSCH scheduled by DCI. Specifically, the UE may use, for PUSCH transmission, the spatial relation information (for example, an RRC information element “spatialRelationInfo”) of the SRS resource determined on the basis of the value (for example, the SRI) of the field.

In a case where codebook based transmission is used for the PUSCH, the UE may be configured with two SRS resource by RRC and indicated with one of the two SRS resources by the DCI (a field of one bit). In a case where non-codebook based transmission is used for the PUSCH, the UE may be configured with four SRS resource by RRC and indicated with one of the four SRS resources by the DCI (a field of two bits). To use a spatial relation other than the spatial relations of the two or four configured by the RRC, RRC reconfiguration is needed.

Note that a DL-RS can be configured for the spatial relation of the SRS resource to be used for the PUSCH. For example, for the SP-SRS, the UE may be configured with spatial relations of a plurality of (for example, up to 16) SRS resources by RRC and indicated with one of the plurality of SRS resources by a MAC CE.

### (DL Receive Beam Management)

The UE may be configured with one or more TCI states for the serving cell. The UE may complete switching of the active TCI state in a delay time. In a case where an active TCI state is updated by the MAC CE, from when the updated TCI state (target TCI state) is applied (how long the delay time is) depends on whether or not the target TCI state is known (measured). When the target TCI is unknown (unmeasured), the UE may apply the target TCI state after the time when the target TCI turns to be known.

In a case where the following plurality of known conditions for TCI state (conditions for the TCI state to be considered known) are satisfied, the target TCI state is known.
In a period (TCI switch period, TCI switching period) from the last transmission of an RS resource used for an L1-RSRP measurement report for the target TCI state to completion of active TCI state switch, the RS resource for the L1-RSRP measurement is an RS in the target TCI state or an RS QCLed with the target TCI state.
In the TCI switch period, a TCI state switch command is received within 1280 ms from the last transmission of the RS resource for report or measurement of a beam.
In the TCI switch period, the UE transmits at least one L1-RSRP report for the target TCI state before the TCI state switch command.
In the TCI switch period, the target TCI state is in a detectable state (detectable).
In the TCI switch period, the SSB associated with the target TCI state is in a detectable state.
In the TCI switch period, the signal-to-noise ratio (SNR) of the target TCI state is −3 dB or higher.

In a case where the plurality of known conditions for the TCI state are not satisfied, the target TCI state is unknown.

In a case where the target TCI state is known, the UE can receive, in response to reception of a PDSCH for carrying a MAC CE activation command in slot n, a PDCCH having the target TCI state in the serving cell in which the TCI state switch occurs before slot n+T_{HARQ}+(3 ms+TOₖ*(T_{first-SSB}+T_{SSB-proc}))/NR slot length. The UE can receive a PDCCH having an old TCI state (before the update) until slot n+T_{HARQ}(3 ms+TOₖ*(T_{first-SSB}))/NR slot length.

Here, T_{HARQ} denotes a time period between DL data transmission and positive acknowledgement (acknowledgement). T_{first-SSB} denotes a time period from when the MAC CE command is decoded by the UE until the first SSC transmission. T_{SSB-proc} corresponds to 2 ms. TOₖ is 1 when the target TCI state is not in an active TCI state list for the PDSCH and is otherwise 0.

In a case where the target TCI state is unknown, the UE can receive, in response to the PDSCH reception for carrying the MAC CE activation command in slot n, a PDCCH having the target TCI state in the serving cell in which the TCI state switch occurs before slot n+T_{HARQ}+(3 ms+T_{L1-RSRP}+TOᵤₖ*(T_{first-SSB}+T_{SSB-proc}))/NR slot length. The UE can receive a PDCCH having an old TCI state (before the update) until slot n+T_{HARQ}+(3 ms+T_{L1-RSRP}+TOᵤₖ*(T_{first-SSB}))/NR slot length.

Here, T_{L1-RSRP} denotes a time period for L1-RSRP measurement for improvement of a receive beam. T_{L1-RSRP} for the SSB is an L1-RSRP measurement period TL1-RSRPMeasurementPeriodSSB based on the SSB in a case where it is assumed that M=1 and T_{Report}=0. T_{L1-RSRP} for the CSI-RS is an L1-RSRP measurement period T_{L1-RSRP_Measurement_Period_CSI-RS} based on the CSI-RS in a case where it is assumed that M=1 and T_{Report}=0 for a periodic CSI-RS and an aperiodic CSI-RS when the number of resources in the resource set is at least equal to MaxNumberRxBeam. TOᵤₖ is 1 for CSI-RS based L1-RSRP measurement and is 0 for SSB based L1-RSRP measurement when the TCI state switch includes QCL type D. TOᵤₖ is 1 when the TCI state switch includes any of the other QCL types. When the TCI state switch includes only QCL type A, QCL type B, or QCL type C, T_{L1-RSRP_Measurement_Period_SSB}=0 for the SSB in FR2, and T_{L1-RSRP_Measurement_Period_CSI-RS}=0 in FR2. When the TCI state switch includes QCL type D, T_{first-SSB} denotes a time period until the first SSB measurement after the L1-RSRP measurement. For the other ALC type, T_{first-SSB} denotes a time period until the first SSC transmission after the MAC CE command is decoded by the UE. For the target TCI state, the SSB is QCL type A or QCL type C.

Switch timing to the target TCI state in a case where the target TCI state is unknown may be timing obtained by adding TL1-RSRP to switch timing to the target TCI state in a case where the target TCI state is known.

### (Pathloss RS)

A pathloss PL_{b,f,c}(q_{d}) [dB] in transmit power control for each of the PUSCH, the PUCCH, and the SRS is calculated by the UE by using an index q_{d} of a reference signal (RS, pathloss reference RS (PathlossReferenceRS)) for downlink BWP associated with an active UL BWP b of a carrier f of a serving cell c. In the present disclosure, the pathloss reference RS, a pathloss (PL)-RS, the index q_{d}, an RS used for pathloss calculation, and an RS resource used for pathloss calculation may be interpreted interchangeably. In the present disclosure, calculation, estimation, measurement, and track may be interpreted interchangeably.

It is under study whether or not to change an existing mechanism of a higher layer filtered RSRP for pathloss measurement in a case where the pathloss RS is updated by the MAC CE.

In the case where the pathloss RS is updated by the MAC CE, pathloss measurement based on the L1-RSRP may be applied. The higher layer filtered RSRP may be used for the pathloss measurement at available timing after the MAC CE for the update of the pathloss RS, and the L1-RSRP may be used for the pathloss measurement before the higher layer filtered RSRP is applied. The higher layer filtered RSRP may be used for the pathloss measurement at available timing after the MAC CE for the update of the pathloss RS, and the higher layer filtered RSRP of the previous pathloss RS may be used before the timing. Similarly to operation in Rel. 15, the higher layer filtered RSRP may be used for the pathloss measurement, and the UE may track all the pathloss RS candidates configured by the RRC. The maximum number of pathloss RSs configurable by the RRC may depend on UE capability. In a case where the maximum number of pathloss RSs configurable by the RRC is X, X or fewer path loss RS candidates may be configured by the RRC, and a pathloss RS may be selected from among the configured pathloss RS candidates on the basis of the MAC CE. The maximum number of pathloss RSs configurable by the RRC may be 4, 8, 16, 64, or the like.

In the present disclosure, the higher layer filtered RSRP, a filtered RSRP, and a layer 3 filtered RSRP may be interpreted interchangeably.

### (Default Spatial Relation and Default PL-RS)

In Rel. 15, separate MAC CEs, specifically, a MAC CE for activation/deactivation of a PUCCH spatial relation and a MAC CE for activation/deactivation of an SRS spatial relation, are needed. The PUSCH spatial relation is in conformity with the SRS spatial relation.

In Rel. 16, at least one of the MAC CE for activation/deactivation of a PUCCH spatial relation and the MAC CE for activation/deactivation of an SRS spatial relation need not necessarily be used.

In a case where neither the spatial relation for the PUCCH nor the PL-RS is configured in FR2, default assumptions of the spatial relation and the PL-RS (default spatial relation and default PL-RS) are applied for the PUCCH. In a case where neither the spatial relation for the SRS nor the PL-RS is configured in FR2, the default assumptions of the spatial relation and the PL-RS (default spatial relation and default PL-RS) are applied for the PUSCH and the SRS scheduled by DCI format 0_1.

In a case where a CORESET is configured in the active DL BWP in a CC, the default spatial relation and the default PL-RS may be the TCI state or the QCL assumption of the CORESET having the lowest CORESET ID in the active DL BWP. In a case where no CORESET is configured in the active DL BWP in the CC, the default spatial relation and the default PL-RS may be an active TCI state having the lowest ID of the PDSCH in the active DL BWP.

In Rel. 15, the spatial relation of the PUSCH scheduled by DCI format 0_0 is in conformity with the spatial relation of the PUCCH resource having the lowest PUCCH resource ID among the active spatial relations of the PUCCH in the same CC. A network needs to update all the PUCCH spatial relations in the SCell even when the PUCCH is not transmitted in the SCell.

In Rel. 16, no PUCCH configuration for the PUSCH scheduled by DCI format 0_0 is needed. The default spatial relation and the default PL-RS are applied for the PUSCH scheduled by DCI format 0_0.

For accurate pathloss measurement for transmit power control, the UE of Rel. 15 is configured with up to four PL-RSs by RRC signaling. Even when the UL transmit beam (spatial relation) is updated using the MACE CE, the PL-RS cannot be updated by the MAC CE.

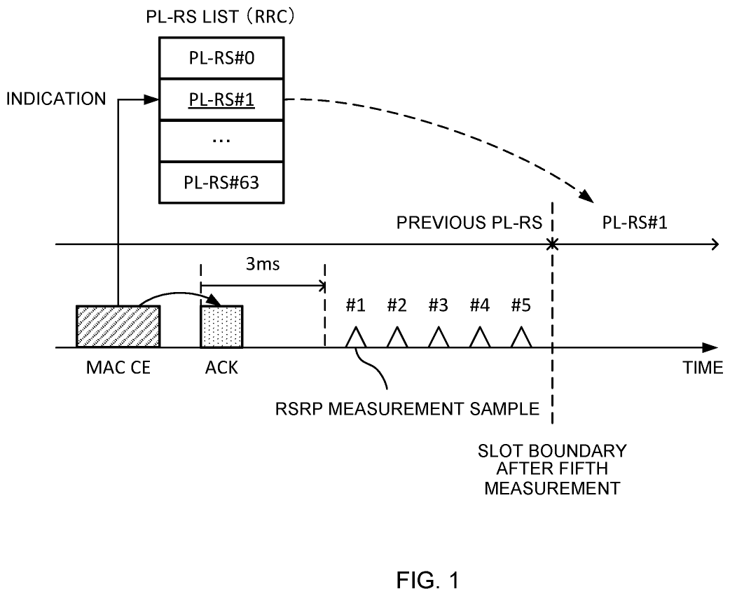

As shown in FIG. 1, the UE of Rel. 16 is configured with up to 64 PL-RSs by RRC signaling and indicated (activated) with one of the PL-RSs by the MAC CE. It is necessary for the UE to track up to four active PL-RSs for all the UL channels (the SRS, the PUCCH, and the PUSCH). Tracking a PL-RS may be equal to calculating a pathloss based on measurement of the PL-RS and retaining (storing) the pathloss.

For the pathloss calculation, a higher layer filtered RSRP (the average based on a plurality of RSRP measurements) is used. As shown in FIG. 1, in a case where a PL-RS is updated by a MAC CE (a case where PL-RS #1 different from the PL-RS (previous PL-RS) used for the pathloss calculation in a PL-RS list configured by RRC is indicated by the MAC CE), the first RSRP measurement instance 3 ms after transmission of ACK for the MAC CE may be used as the first RSRP measurement sample to apply PL-RS #1 to the slot boundary after the fifth RSRP measurement sample (use PL-RS #1 for the pathloss calculation).

In the present disclosure, RSRP measurement, an RSRP measurement sample, an RSRP measurement resource, RSRP measurement timing, an RSRP measurement instance, a PL-RS measurement sample, a PL-RS measurement resource, PL-RS measurement, PL-RS measurement timing, and a PL-RS measurement instance may be interpreted interchangeably.

In a case where the TCI state for the PDCCH or the PDSCH is updated by the MAC CE, the PL-RS is also updated to the TCI state. It is not clear how to apply the updated PL-RS in a case where the UE applies the default spatial relation and the default PL-RS. Since measurement for the higher layer filtered RSRP requires time, the updated PL-RS cannot be applied immediately after the update of the TCI state.

A QCL type D-RS may not possibly be a periodic RS (P-RS). In addition, the UE cannot use any RS other than the periodic RS for measurement of a pathloss. The QCL type D-RS in the TCI state that is configured in the CORESET or activated for PDSCH transmission is a CSI-RS resource for beam management or a CSI-RS for tracking or CSI acquisition. This CSI-RS may be any of periodic (P-CSI-RS), semi-persistent (SP-CSI-RS) or aperiodic (A-CSI-RS).

A case where the QCL type D-RS in the TCI state for the PDCCH is an A-CSI-RS or an SP-CSI-RS is one of Cases 1 to 3 below.
{Case 1}

Both the QCL type A-RS and the QCL type D-RS are TRSs (each being a periodic TRS (P-TRS) or an aperiodic TRS (A-TRS)).
{Case 2}

The QCL type A-RS is a TRS (being a P-TRS or an A-TRS), and the QCL type D-RS is a CSI-RS configured with repetition (having the higher layer parameter “repetition”).
{Case 3}

Both the QCL type A-RS and the QCL type D-RS are CSI-RSs not configured with TRS information and repetition (not having the higher layer parameters “repetition” and “trs-Info”).

The NZP-CSI-RS resource in the NZP-CSI-RS resource set configured with repetition is transmitted by using the same beam (spatial domain transmission filter) and the same number of ports over a plurality of symbols.

Cases where the QCL type D-RS in the TCI state for the PDSCH is an A-CSI-RS or an SP-CSI-RS include Cases 1 to 3 described above.

For the A-CSI-RS resource in the NZP-CSI-RS resource set configured with TRS information, the UE assumes that the TCI state indicates QCL type A with a P-CSI-RS resource in the NZP-CSI-RS resource set configured with the TRS information and QCL type D with the same P-CSI-RS resource if applicable. In other words, in a case where an A-TRS is configured, a P-TRS is configured without fail. A P-TRS is configured for QCL type A of the TCI state of the A-TRS.

However, when QCL type D-RS for the default PL-RS is an A-CSI-RS or an SP-CSI-RS, the UE cannot measure a pathloss appropriately.

In view of this, the inventors of the present invention came up with the idea of a method of appropriately determining a default PL-RS.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interpreted interchangeably. In the present disclosure, a cell, a CC, a carrier, a BWP, and a band may be interpreted interchangeably. In the present disclosure, an index, an ID, an indicator, and a resource ID may be interpreted interchangeably. In the present disclosure, an RRC parameter, a higher layer parameter, an RRC information element (IE), and an RRC message may be interpreted interchangeably.

In the present disclosure, a TCI state, a QCL assumption, a QCL parameter, a spatial domain reception filter, a UE spatial domain reception filter, a UE receive beam, a DL receive beam, a DL precoding, a DL precoder, a DL-RS, an RS of QCL type D of a TCI state or a QCL assumption, and an RS of QCL type A of a TCI state or a QCL assumption may be interpreted interchangeably. In the present disclosure, a QCL type X-RS, a DL-RS associated with QCL type X, a DL-RS having QCL type X, a source of a DL-RS, an SSB, and a CSI-RS may be interpreted interchangeably.

In the present disclosure, a spatial relation, spatial relation information, a spatial relation assumption, a QCL parameter, a spatial domain transmission filter, a UE spatial domain transmission filter, a UE transmit beam, a UL transmit beam, a UL precoding, a UL precoder, an RS having a spatial relation, a DL-RS, a QCL assumption, an SRI, a spatial relation based on an SRI, and a UL TCI may be interpreted interchangeably.

In the present disclosure, a TRS, a reference signal for tracking, a CSI-RS for tracking, a CSI-RS configured with TRS information (a higher layer parameter trs-Info), a CSI-RS including TRS information, and an NZP-CSI-RS resource in an NZP-CSI-RS resource set including TRS information may be interpreted interchangeably.

In the present disclosure, a repetition CSI-RS, a CSI-RS configured with repetition (a higher layer parameter repetition), a CSI-RS with repetition, and an NZP-CSI-RS resource in an NZP-CSI-RS resource set with repetition may be interpreted interchangeably.

In the present disclosure, DCI format 0_0, DCI not including an SRI, DCI not including an indication of a spatial relation, and DCI not including a CIF may be interpreted interchangeably. In the present disclosure, DCI format 0_1, DCI including an SRI, DCI including an indication of a spatial relation, and DCI including a CIF may be interpreted interchangeably.

In the present disclosure, a dedicated PUCCH and a PUCCH based on a dedicated PUCCH configuration (PUCCH-Config) may be interpreted interchangeably. In the present disclosure, a dedicated SRS, an SRS based on a dedicated SRS configuration (SRS-Config) may be interpreted interchangeably.

### (Radio Communication Method)

In the present disclosure, a UL signal, a UL channel, a specific UL signal, and a specific type of UL signal may be interpreted interchangeably. The specific UL signal may be at least one of a PUCCH (dedicated PUCCH), an SRS (dedicated SRS), a PUSCH scheduled by DCI format 0_1, and a PUSCH scheduled by DCI format 0_0.

In the present disclosure, a DL signal, a DL channel, a specific DL signal, a specific type of DL signal, a specific DL channel, and a specific type of DL channel may be interpreted interchangeably. The specific DL signal may be at least one of a PDCCH, a PDSCH, and a CORESET.

In the present disclosure, a TCI state updated by a MAC CE, a TCI state activated by a MAC CE, a TCI state indicated by a MAC CE, a target TCI state, a TCI state of a PL-RS activated by a MAC CE, a TCI state referred to by at least one of a default spatial relation and a default PL-RS of a specific UL signal, and a reference TCI state may be interpreted interchangeably.

In the present disclosure, X being QCLed with Y (X is quasi co-located (QCLed) with Y), X and Y being QCLed with QCL type D (X and Y are quasi co-located with ‘QCL-TypeD’), X and Y being QCLed with respect to QCL type D (X and Y are quasi co-located with respect to ‘QCL-TypeD’), and X and Y being in a relationship of QCL type D may be interpreted interchangeably. X and Y may each be an RS or an RS resource.

In the present disclosure, a periodic RS, a P-RS, a periodic P-CSI-RS, and an SSB may be interpreted interchangeably. In the present disclosure, a semi-persistent RS, an SP-RS, a semi-persistent CSI-RS, and an SP-CSI-RS may be interpreted interchangeably. In the present disclosure, an aperiodic RS, an A-RS, an aperiodic CSI-RS, and an A-CSI-RS may be interpreted interchangeably.

In the present disclosure, a P-TRS corresponding to an A-TRS and a P-TRS configured with QCL type A in the TCI state of an A-TRS may be interpreted interchangeably.

The UE may receive configuration information related to a certain UL signal. The configuration information may include at least one of a PUCCH configuration (PUCCH-Config, PUCCH-Resource), a PUSCH configuration (PUSCH-Config), an SRS configuration (SRS-Config), and a CORESET configuration (ControlResourceSet).

In a case where the configuration information of the specific UL signal satisfies an application condition and the TCI state of a specific DL signal is updated by a MAC CE, an RS (a QCL type D-RS or a QCL type A-RS) of the TCI state (the reference TCI state) of the specific DL signal may be used for at least one of the default spatial relation and the default PL-RS of the specific UL signal.

The application condition may need at least one of the frequency of the specific UL signal being within a specific frequency range (FR), a specific higher layer parameter corresponding to the specific UL signal being configured, a specific UL signal condition corresponding to the specific UL signal being satisfied, and a target TCI state being known.

The specific frequency range may be FR2 or may be a frequency range other than FR1.

The specific higher layer parameter may correspond to the specific UL signal. In a case where the specific UL signal is a PUSCH scheduled by DCI format 0_0, the specific higher layer parameter corresponding to the specific UL signal may be enable default beam pathloss information (enableDefaultBeamPlForPUSCH0_0). In a case in a case where the specific UL signal is a dedicated PUCCH, the specific higher layer parameter corresponding to the specific UL signal may be enable default beam pathloss information (enableDefaultBeamPlForPUCCH). In a case where the specific UL signal is at least one of a dedicated SRS and a PUSCH scheduled by DCI format 0_1, the specific higher layer parameter corresponding to the specific UL signal may be enable default beam pathloss information (enableDefaultBeamPlForSRS).

A combination of the specific UL signal and a specific UL signal condition corresponding to the specific UL signal may corresponds to at least one of specific UL signals 1 to 4 below.
{Specific UL Signal 1}

The specific UL signal is a dedicated PUCCH. The specific UL signal condition is that neither a spatial relation nor a PL-RS is configured for the specific UL signal.
{Specific UL Signal 2}

The specific UL signal is a dedicated SRS. The specific UL signal condition is that neither a spatial relation nor a PL-RS is configured for the specific UL signal.
{Specific UL Signal 3}

The specific UL signal is a PUSCH scheduled by DCI format 0_0. The specific UL signal condition is that no PUCCH resource configuration is present in an active UL BWP or that no active spatial relation is present in a PUCCH resource in the active UL BWP, for the specific UL signal.
{Specific UL Signal 4}

The specific UL signal is a PUSCH scheduled by DCI format 0_1. The specific UL signal condition is that an SRS resource (an SRS resource indicated by an SRI) corresponding to the specific UL signal includes neither a spatial relation nor a PL-RS for the specific UL signal.

In a case where a CORESET is configured in an active DL BWP in a CC of the specific UL signal, the specific DL signal may be a PDCCH. In a case where no CORESET is configured in the active DL BWP in the CC of the specific UL signal, the specific DL signal may be a PDSCH.

The UE may measure an RSRP by using the default PL-RS, calculate a pathloss of the specific UL signal on the basis of a measurement result, and determine a transmit power of the specific UL signal on the basis of the pathloss.

### Embodiment 1

In a case where a QCL type D-RS in a TCI state (reference TCI state) of a PDCCH or a PDSCH for a default PL-RS/default spatial relation is not a P-RS and a QCL type A-RS in the reference TCI state is a P-RS, the UE may use the QCL type A-RS for the default PL-RS/default spatial relation.

In a case where the QCL type A-RS in the reference TCI state is not a P-RS, the UE may be according to at least one of Embodiments 2 to 4 or may use an RS resource from an SSB used by the UE to obtain an MIB, for the default PL-RS/default spatial relation.

According to this embodiment, even in a case where the QCL type D-RS in the reference TCI state is not a P-RS, the UE can determine an appropriate default PL-RS.

### Embodiment 2>

In a case where a QCL type D-RS in a TCI state (reference TCI state) of a PDCCH or a PDSCH for a default PL-RS/default spatial relation is not a P-RS and at least one of a QCL type A-RS and a QCL type D-RS in the reference TCI state is a TRS, the UE may use a P-RS related to the TRS, for the default PL-RS/default spatial relation.

In a case where the TRS is a P-TRS, the UE may use the P-TRS for the default PL-RS/default spatial relation or may use an SSB QCLed with the P-TRS for the default PL-RS/default spatial relation.

In a case where the TRS is an A-TRS, the UE may use the P-TRS corresponding to the A-TRS for the default PL-RS/default spatial relation or may use an SSB QCLed with the P-TRS corresponding to the A-TRS, for the default PL-RS/default spatial relation. The P-TRS corresponding to the A-TRS may be a P-TRS of QCL type A in the TCI state of the A-TRS.

In a case where at least one of the QCL type A-RS and the QCL type D-RS in the reference TCI state is not a TRS, the UE may follow at least one of Embodiments 1, 3, and 4 or may use the RS resource from the SSB used by the UE to obtain an MIB, for the default PL-RS/default spatial relation.

According to this embodiment, even in a case where the QCL type D-RS in the reference TCI state is not a P-RS, the UE can determine an appropriate default PL-RS.

### Embodiment 3

Cases where a QCL type D-RS in a TCI state (reference TCI state) of a PDCCH or a PDSCH for a default PL-RS/default spatial relation is an A-CSI-RS or an SP-CSI-RS are classified into Cases 1 to 3 described above.

In a case where the QCL type D-RS in the reference TCI state is an A-CSI-RS or an SP-CSI-RS, an RS used for the default PL-RS/default spatial relation may depend on which one of Cases 1 to 3 described above corresponds to the reference TCI state.
{Case 1}

In Case 1, both the QCL type A-RS and the QCL type D-RS in the reference TCI state are each a P-TRS or an A-TRS.

In a case where the QCL type D-RS in the reference TCI state is a P-TRS, the UE may use the P-TRS for the default PL-RS/default spatial relation or may use an SSB QCLed with the P-TRS for the default PL-RS/default spatial relation.

In a case where the QCL type D-RS in the reference TCI state is an A-TRS, the UE may use the P-TRS corresponding to the A-TRS for the default PL-RS/default spatial relation or may use an SSB QCLed with the P-TRS corresponding to the A-TRS, for the default PL-RS/default spatial relation. The P-TRS corresponding to the A-TRS may be a P-TRS of QCL type A in the TCI state of the A-TRS.
{Case 2}

In Case 2, the QCL type A-RS in the reference TCI state is a periodic TRS (P-TRS) or an aperiodic TRS (A-TRS), and the QCL type D-RS in the reference TCI state is a CSI-RS configured with repetition (having the higher layer parameter repetition).

In Case 2, the UE may operate in accordance with either of Case 2 Operations 1 and 2.
{{Case 2 Operation 1}}

In Case 2, the QCL type A-RS in the reference TCI state is a TRS. The UE may use the QCL type A-RS in the reference TCI state for the default PL-RS/default spatial relation.

In a case where the QCL type A-RS in the reference TCI state is a P-TRS, the UE may use the P-TRS for the default PL-RS/default spatial relation or may use an SSB QCLed with the P-TRS for the default PL-RS/default spatial relation.

In a case where the QCL type A-RS in the reference TCI state is an A-TRS, the UE may use the P-TRS corresponding to the A-TRS for the default PL-RS/default spatial relation or may use an SSB QCLed with the P-TRS corresponding to the A-TRS, for the default PL-RS/default spatial relation. The P-TRS corresponding to the A-TRS may be a P-TRS of QCL type A in the TCI state of the A-TRS.
{{Case 2 Operation 2}}

In Case 2, the QCL type D-RS in the reference TCI state is a CSI-RS configured with repetition.

In a case where the CSI-RS is a P-CSI-RS or a P-TRS, the UE may use the P-CSI-RS or the P-TRS for the default PL-RS/default spatial relation.

In a case where an SSB QCLed with the CSI-RS is present, the UE may use the SSB for the default PL-RS/default spatial relation.

In a case where the SSB QCLed with the CSI-RS is SSB #M of another CC (a CC different from the CC to which the default PL-RS/default spatial relation is applied), the UE may use SSB #M of such another CC for the default PL-RS/default spatial relation.

In a case where the SSB QCLed with the CSI-RS is SSB #M of such another CC, SSB #M of the former CC may be used for the default PL-RS/default spatial relation. Since a plurality of CCs may be different from each other in pathloss, the UE may use an SSB of the former CC (the CC to which the default PL-RS/default spatial relation is applied) with the same SSB index as the SSB index of such another CC.
{Case 3}

In Case 3, both the QCL type A-RS and the QCL type D-RS in the reference TCI state are CSI-RSs not configured with TRS information and repetition (not having the higher layer parameters “repetition” and “trs-Info”).

Since neither the QCL type A-RS nor the QCL type D-RS in the reference TCI state is a TRS, Embodiments 1 and 2 are not preferable. The UE, similarly to Case 2 Operation 2, may operate in accordance with the following operation.

Note that the QCL type D-RS in the reference TCI state is a CSI-RS not configured with repetition.

In a case where the CSI-RS is a P-CSI-RS or a P-TRS, the UE may use the P-CSI-RS or the P-TRS for the default PL-RS/default spatial relation.

In a case where an SSB QCLed with the CSI-RS is present, the UE may use the SSB for the default PL-RS/default spatial relation.

In a case where the SSB QCLed with the CSI-RS is SSB #M of another CC (a CC different from the CC to which the default PL-RS/default spatial relation is applied), the UE may use SSB #M of such another CC for the default PL-RS/default spatial relation.

In a case where the SSB QCLed with the CSI-RS is SSB #M of such another CC, SSB #M of the former CC may be used for the default PL-RS/default spatial relation. Since a plurality of CCs may be different from each other in pathloss, the UE may use an SSB of the former CC (the CC to which the default PL-RS/default spatial relation is applied) with the same SSB index as the SSB index of such another CC.

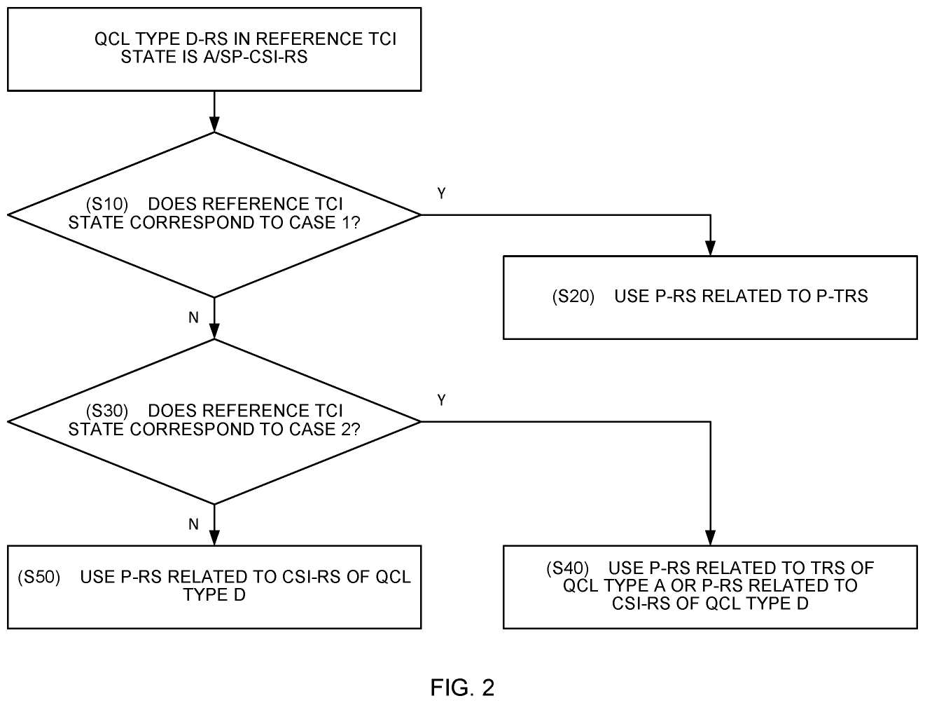

In a case where the QCL type D-RS in the reference TCI state is an A-CSI-RS or an SP-CSI-RS, the UE may operate as shown in FIG. 2. In a case where the reference TCI state corresponds to Case 1 (S10: Y), the UE may use a P-RS related to a P-TRS, for the default PL-RS/default spatial relation (S20). In a case where the reference TCI does not correspond to Case 1 (S10: N) and the reference TCI corresponds to Case 2 (S30: Y), the UE may use a P-RS related to a TRS of QCL type A in the reference TCI state or a P-RS related to a CSI-RS of QCL type D in the reference TCI state (S40). In a case where the reference TCI does not correspond to Case 2 (S30: N, a case where the reference TCI state corresponds to Case 3), the UE may use a P-RS related to the CSI-RS of QCL type D in the reference TCI state (S50).

According to this embodiment, even in a case where the QCL type D-RS in the reference TCI state is not a P-RS, the UE can determine an appropriate default PL-RS.

### Embodiment 4

In a case where the QCL type D-RS in the reference TCI state is an A-CSI-RS or an SP-CSI-RS, an RS used for the default PL-RS/default spatial relation may depend on whether the QCL type D-RS in the reference TCI state is an A-CSI-RS or an SP-CSI-RS.

In a case where the QCL type D-RS in the reference TCI state is an A-CSI-RS, the UE may determine the default PL-RS/default spatial relation in accordance with any one of Embodiments 1 to 3.

In a case where the QCL type D-RS in the reference TCI is an SP-CSI-RS, UE operation may depend on whether or not the SP-CSI-RS satisfies a measurement condition.

The measurement condition may be that N times of measurement (N or more times of measurement) are performed on the SP-CSI-RS or that the SP-CSI-RS is not deactivated during the N times of measurement. The measurement may provide an L1-RSRP or an L1-SINR. Different measurement conditions may be used depending on whether the reference TCI state is known or unknown.

The N times of measurement may be N times of measurement performed until specific timing based on reception of a MAC CE for update to the reference TCI state (target TCI state) (a MAC CE activating the reference TCI state) or may be N times of measurement performed after the specific timing. The specific timing may be timing of the reception of the MAC CE for the update to the reference TCI state or may be timing a specific time period after transmission of ACK for the MAC CE for the update to the reference TCI state.

The number N of measurement samples may be defined in a specification, may be configured by an RRC parameter, or may be a value reported with UE capability information. N may be five or may be another value.

The specific time period may be defined in a specification, may be configured by an RRC parameter, or may be a value reported with UE capability information. The specific time period may be 3 ms or may be another value. The specific time period may be expressed with X [ms] or may be expressed with X [slot].

In a case where the QCL type D-RS in the reference TCI state is an SP-CSI-RS and the SP-CSI-RS satisfies the measurement condition, the UE may calculate a pathloss of the specific UL signal on the basis of a measurement result (for example, an RSRP or an SINR) of the SP-CSI-RS. The UE may use the SP-CSI-RS for the default PL-RS/default spatial relation.

In a case where the QCL type D-RS in the reference TCI is an SP-CSI-RS and the SP-CSI-RS does not satisfy the measurement condition, the UE may operate in accordance with any of SP-CSI-RS Operations 1, 2 and 3 below.
{SP-CSI-RS Operation 1}

The UE may calculate a pathloss of the specific UL signal on the basis of a measurement result(s) (for example, fewer than N measurement result(s)) of the SP-CSI-RS.
{SP-CSI-RS Operation 2}

The UE may determine the default PL-RS/default spatial relation in accordance with any one of Embodiments 1 to 3.
{SP-CSI-RS Operation 3}

Either of SP-CSI-RS Operation 1 or 2 may be configured by higher layer signaling.

The UE may report UE capability information indicating whether or not the UE supports at least one of SP-CSI-RS Operations 1 and 2. The UE may be configured with either of SP-CSI-RS Operation 1 or 2 on the basis of the UE capability information by higher layer signaling.

According to this embodiment, even in a case where the QCL type D-RS in the reference TCI state is not a P-RS, the UE can determine an appropriate default PL-RS.

### Embodiment 5

The UE may report UE capability information related to at least one operation of Embodiments 1 to 4. A UE capability method may include at least one of the following pieces of information.
Whether or not to support at least one operation of Embodiments 1 to 4.
A case supporting the operation. For example, at least one of Cases 1 to 3.
Type of a TRP/CSI-RS. For example, whether or not the type is a TRS (a CSI-RS configured with TRS information). For example, whether or not the type is a CSI-RS with repetition (a CSI-RS configured with repetition).

The UE may determine a default PL-RS in accordance with at least one operation of Embodiments 1 to 4. In this case, the UE may use a QCL type D-RS in a reference TCI state for a default spatial relation irrespective of whether the QCL type D-RS in the reference TCI state is an A-RS, an SP-RS, or an A-RS. In this way, the UE can select a more appropriate UL beam without being affected by transmit power control.

In a case where the QCL type D-RS in the reference TCI state is an A-RS or an SP-RS, the UE may use the QCL type D-RS in the reference TCI state for both the default PL-RS and the default spatial relation. In this way, it is possible to use the same DL-RS for the default PL-RS and the default spatial relation to thereby perform transmit power control appropriately, which can improve communication quality.

According to this embodiment, the UE can determine an appropriate default PL-RS.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

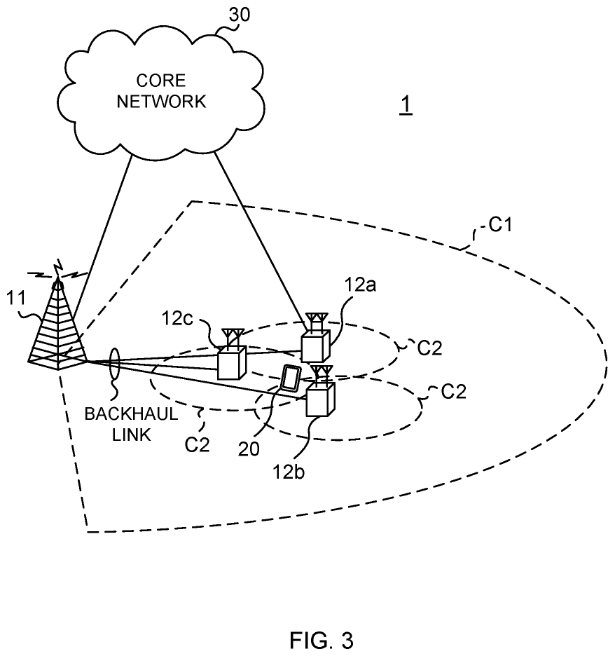

FIG. 3 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (SGCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

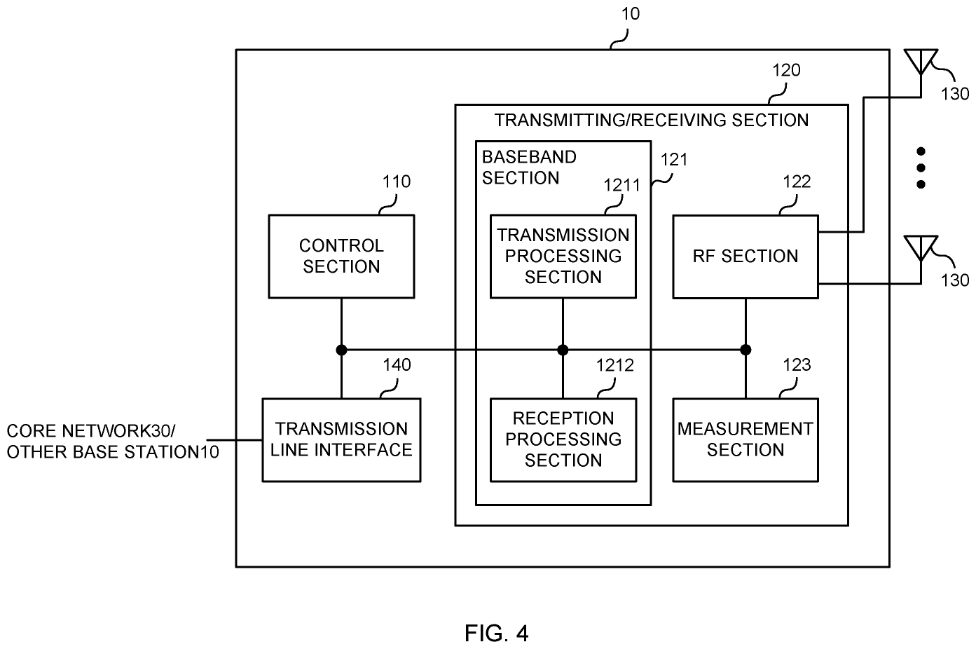

FIG. 4 is a diagram to show an example of a structure of the base station according to one embodiment. The base station 10 includes a control section 110, a transmitting/receiving section 120, transmitting/receiving antennas 130 and a transmission line interface (communication path interface) 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit configuration information related to an uplink signal. In a case where the configuration information satisfies an application condition and quasi-co-location (QCL) type D in a transmission configuration indication (TCI) state for a downlink channel is not a periodic reference signal, the transmitting/receiving section 120 may receive the uplink signal with a transmit power based on a reference signal of at least one of QCL type A and the QCL type D in the TCI state.

### (User Terminal)

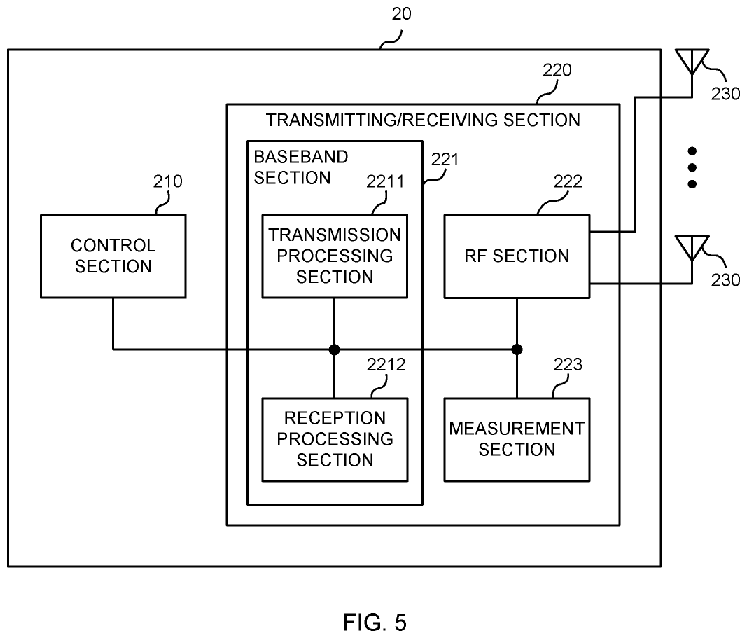

FIG. 5 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive configuration information related to an uplink signal (for example, a specific UL signal). In a case where the configuration information satisfies an application condition and quasi-co-location (QCL) type D in a transmission configuration indication (TCI) state for a downlink channel is not a periodic reference signal, the control section 210 may use a reference signal of at least one of QCL type A and the QCL type D in the TCI state, for calculation of a pathloss of the uplink signal.

The reference signal may be at least one of a periodic reference signal of QCL type A, a periodic reference signal related to a reference signal for tracking, and a periodic reference signal QCLed with a QCL type D reference signal.

The reference signal may depend on either a configuration of QCL type A and QCL type D in the TCI state or whether QCL type D in the TCI state is a semi-persistent channel state information reference signal (SP-CSI-RS) or an aperiodic CSI-RS.

The uplink signal may be at least one of a physical uplink control channel, a sounding reference signal, a physical uplink shared channel scheduled by downlink control information format 0_0, and a physical uplink shared channel scheduled by downlink control information format 0_1. The application condition may need at least one of the configuration information not including spatial relation information for the uplink signal and the configuration information not including a configuration of a pathloss reference signal for the uplink signal.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

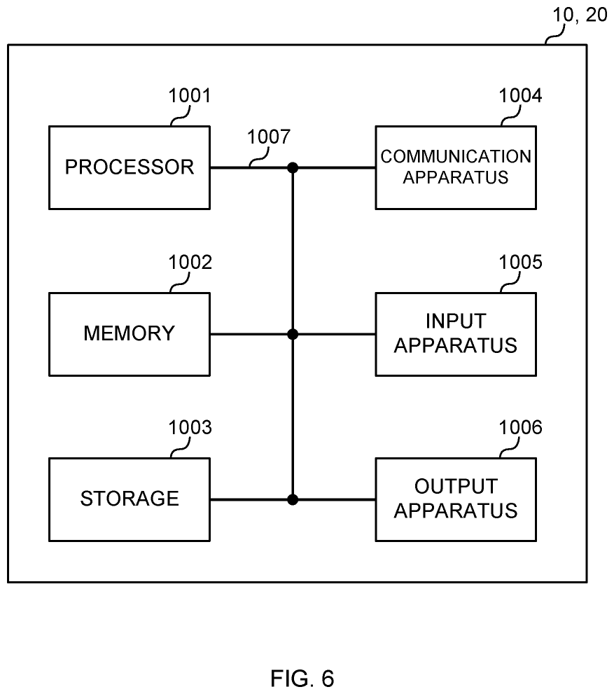

For example, a base station, a user terminal, and so on according to one embodiment of the present disclosure may function as a computer that executes the processes of the radio communication method of the present disclosure. FIG. 6 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (SGWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives configuration information related to an uplink signal; and
a control section that uses, in a case where the configuration information satisfies an application condition and quasi-co-location (QCL) type D in a transmission configuration indication (TCI) state for a downlink channel is not a periodic reference signal, a reference signal of at least one of QCL type A and the QCL type D in the TCI state, for calculation of a pathloss of the uplink signal.

2. The terminal according to claim 1, wherein the reference signal is at least one of a periodic reference signal of the QCL type A, a periodic reference signal related to a reference signal for tracking, and a periodic reference signal QCLed with a QCL type D reference signal.

3. The terminal according to claim 1, wherein the reference signal depends on either a configuration of the QCL type A and the QCL type D in the TCI state or whether the QCL type D in the TCI state is a semi-persistent channel state information reference signal (SP-CSI-RS) or an aperiodic CSI-RS.

4. The terminal according to claim 1, wherein
the uplink signal is at least one of a physical uplink control channel, a sounding reference signal, a physical uplink shared channel scheduled by downlink control information format 0_0, and a physical uplink shared channel scheduled by downlink control information format 0_1, and
as the application condition, at least one of the configuration information not including spatial relation information for the uplink signal and the configuration information not including a configuration of a pathloss reference signal for the uplink signal is needed.

5. A radio communication method for a terminal, the radio communication method comprising:
receiving configuration information related to an uplink signal; and
using, in a case where the configuration information satisfies an application condition and quasi-co-location (QCL) type D in a transmission configuration indication (TCI) state for a downlink channel is not a periodic reference signal, a reference signal of at least one of QCL type A and the QCL type D in the TCI state, for calculation of a pathloss of the uplink signal.

6. A base station comprising:
a transmitting section that transmits configuration information related to an uplink signal; and
a receiving section that receives, in a case where the configuration information satisfies an application condition and quasi-co-location (QCL) type D in a transmission configuration indication (TCI) state for a downlink channel is not a periodic reference signal, the uplink signal with a transmit power based on a reference signal of at least one of QCL type A and the QCL type D in the TCI state.

7. The terminal according to claim 2, wherein the reference signal depends on either a configuration of the QCL type A and the QCL type D in the TCI state or whether the QCL type D in the TCI state is a semi-persistent channel state information reference signal (SP-CSI-RS) or an aperiodic CSI-RS.

8. The terminal according to claim 2, wherein
the uplink signal is at least one of a physical uplink control channel, a sounding reference signal, a physical uplink shared channel scheduled by downlink control information format 0_0, and a physical uplink shared channel scheduled by downlink control information format 0_1, and
as the application condition, at least one of the configuration information not including spatial relation information for the uplink signal and the configuration information not including a configuration of a pathloss reference signal for the uplink signal is needed.

9. The terminal according to claim 3, wherein
the uplink signal is at least one of a physical uplink control channel, a sounding reference signal, a physical uplink shared channel scheduled by downlink control information format 0_0, and a physical uplink shared channel scheduled by downlink control information format 0_1, and
as the application condition, at least one of the configuration information not including spatial relation information for the uplink signal and the configuration information not including a configuration of a pathloss reference signal for the uplink signal is needed.
